(19) United States
(12) Patent Application Publication
(10) Pub. No.: US 2019/0095940 A1
(43) Pub. Date: Mar. 28, 2019

(54) BIOMETRIC DATA RETRIEVAL AND AUTHENTICATION

(71) Applicant: NCR Corporation, Duluth, GA (US)

(72) Inventor: Yehoshua Zvi Licht, Alpharetta, GA (US)

(21) Appl. No.: 15/719,104

(22) Filed: Sep. 28, 2017

(51) Int. Cl. G06Q 30/02; G06K 9/00

(52) U.S. Cl. CPC G06Q 30/0226; G06Q 30/0225; G06K 9/00288; G06Q 30/0238; G06Q 30/0261; G06Q 30/0269; G06Q 30/0267

(57) ABSTRACT

Systems and methods for authenticating a customer may include receiving, at a computing device comprising a processor, biometric data for the customer; determining, by the computing device, a customer identity bases on the biometric data; and transmitting, by the computing device, a customer profile to a remote computer. The customer identity may be associated with the customer profile.

### BACKGROUND

A loyalty program is a rewards program offered by a company to customers who frequently make purchases. The loyalty program may give a customer advanced access to new products, special sales coupons, or free merchandise. Customers typically register their personal information with the company and are given a membership card, and use that membership card when making a purchase.

### SUMMARY

Systems and methods for authenticating a customer may include receiving, at a computing device comprising a processor, biometric data for the customer; determining, by the computing device, a customer identity bases on the biometric data; and transmitting, by the computing device, a customer profile to a remote computer. The customer identity may be associated with the customer profile.

### BRIEF DESCRIPTION OF THE FIGURES

The above-mentioned and other features and advantages of this invention, and the manner of attaining them, will become more apparent and the invention itself will be better understood by reference to the following description of embodiments of the invention taken in conjunction with the accompanying drawings, wherein:

FIG. 1 shows an operating environment for using biometrics to authenticate a customer consistent with the disclosure;

FIG. 2 shows an example schematic of a computing device;

FIG. 3 shows an example method for authenticating a customer; and

FIG. 4 shows an example method for authenticating a customer.

Corresponding reference characters indicate corresponding parts throughout the several views. The exemplifications set out herein illustrate exemplary embodiments of the invention, and such exemplifications are not to be construed as limiting the scope of the invention any manner.

### DETAILED DESCRIPTION

The following detailed description refers to the accompanying drawings. Wherever possible, the same reference numbers are used in the drawings and the following description to refer to the same or similar elements. While embodiments and examples are described, modifications, adaptations, and other implementations are possible. For example, substitutions, additions, or modifications may be made to the elements and stages illustrated in the drawings, and the systems and methods described herein may be modified by substituting, reordering, or adding stages to the disclosed methods or elements to the discloses systems. Accordingly, the following detailed description does not limit the disclosure. Instead, the proper scope of any invention disclosed herein is defined by the appended claims.

Currently, a customer has to identify himself or herself as a member of a loyalty program should that customer wish to receive the benefits of the loyalty program. For example, when in a checkout line the customer must enter information on a keypad, present a membership card, or otherwise provide identifying information to a cashier. This time consuming and otherwise inefficient.

As disclosed herein, upon entering a retail location, sensors (e.g., cameras) located throughout the retail location may capture various biometric data (e.g., images) of the customer. The sensors may be connected to a store controller. The store controller may be connected to a hub controller. The biometric data may be used by either the store controller or the hub controller to identify the customer. For example, the store controller may use facial recognition technology to identify the customer based on an image captured by a camera in a store and a reference image associated with the customer. In another example, the store controller may forward the image captured by the camera to the hub controller and the hub controller may use facial recognition technology to identify the customer.

Once the customer has been identified, the sensors may be used to track the customer within the retail location. The customer's location can be used to supplement a customer profile associated with the customer. For example, if a user spends a lot of time in a particular section or department of a store and very little or no time in another department or section of the store, then the customer profile for the customer can be updated to include a product preference. For instance, if the customer never visits the cosmetic department but always spends time in the sporting goods department, then the customer profile can be updated to reflect the customer is probably not interested in buying cosmetics, but instead is interested in buying sporting equipment. The granularity of the location data can very between implementation of the systems and methods disclosed herein. For example, within the sporting goods department, the customer may only look at fishing gear and not baseball equipment. Thus, the customer profile can be updated to show the user has an interest in fishing and probably is not interested in baseball.

In addition to using location information to track the customer's shopping preferences, the location information can be used to expedite checkout and other customer service activities. For example, upon the customer reaching a checkout lane, his or her loyalty information can be transferred to the point of sale (POS) device without any interaction from the customer or a cashier. As a result, any discounts or other promotions may be immediately made available to the customer.

In another example, if the customer enters a store and goes directly to the customer service desk, the customer can be identified prior to being greeted by an attendant. By pre-identifying the customer, his or her purchase history can be uploaded to the POS device at the customer service desk for easy reference by an attendant. Furthermore, if the customer is carrying a product not in a bag or other covering, images of the product may be used to identify the product and match the product to the purchase history. Thus, the attendant at the customer service desk will already be ready to process a return or exchange when the customer approaches the customer service desk.

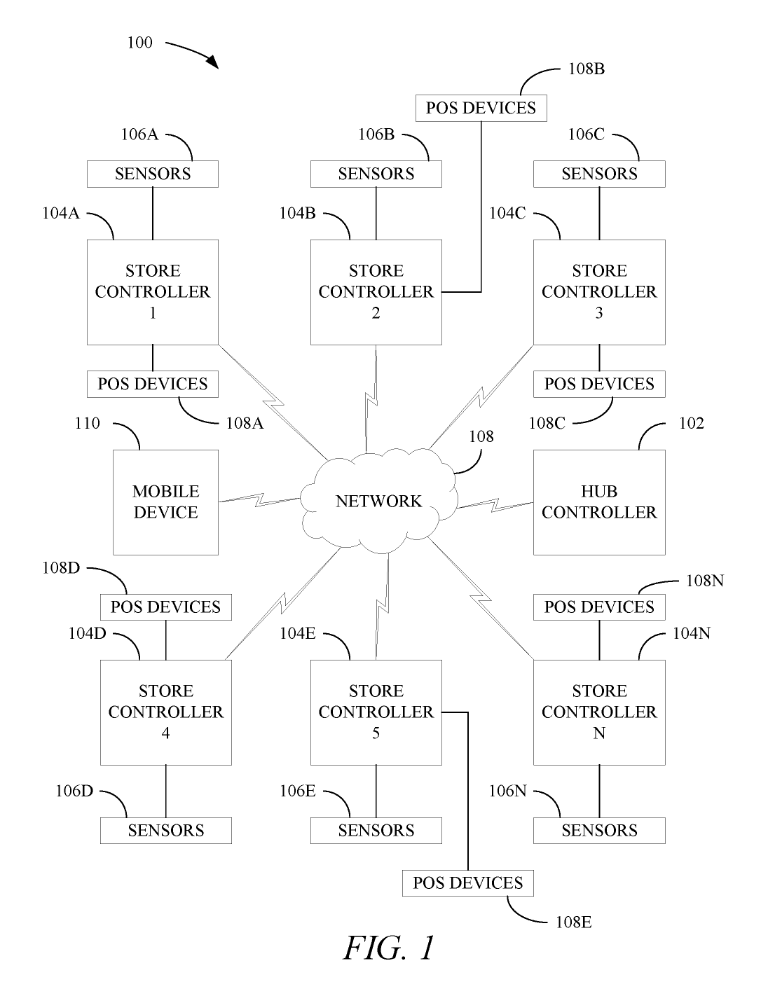

FIG. 1 shows an operating environment 100 for authenticating a customer. The operating environment 100 may include a hub controller 102 and store controllers 104 (labeled individually as 104A, 104B, 104C, 104D, 104E, . . . 104N). Each of the store controllers may be connected to sensors 106 (labeled individually as 106A, 106B, 106C, 106D, 106E, . . . 106N) and POS devices 106 (labeled individually as 106A, 106B, 106C, 106D, 106E, . . . 106N). The hub controller 102 and the store controllers 104 may be connected via a network 108. Non-limiting examples of network 108 include the Internet, a local area network, a wide area network, etc. The hub controller 102 and the store controllers 104 may also communicate with a mobile device 110. The mobile device 110 may be a customer's smart phone, smart watch, or other portable device carried by the customer.

Each of the store controllers 104 may be located at a retail location. The store controllers 104 may control the POS devices 108 and the sensors 106. In addition, the store controllers 104 may send, receive, and process data received from the POS devices 108 and the sensors 106. For example, the store controllers 104 may receive transaction data from the POS devices 108 and transmit the data to the hub controller 102. In another example, the store controllers 104 may analyze the transaction data received from the POS devices 108 and transmit the analyzed data to the hub controller 102.

The store controllers 104 may receive biometric data from the sensors 106 and analyze the biometric data to identify the customer. For example, the sensors 106 may be cameras located throughout a retail location (both inside and outside). The cameras may collect images of the customer as the customer approaches a store and in a parking lot. The images may be transmitted to the store controller where they are analyzed to determine the identity of the customer. For instance, the images may be of the customer's face and facial recognition techniques may be used to match the images to a known image of the customer. In addition, other information, possibly non-biometric data, such as the license plate of the customer's car may be collected. The license plate number may be extracted from the image via object character recognition techniques and matched to a known license plate number of the customer. The non-biometric data may be used to supplement the biometric data.

The store controllers 104 may also transmit the biometric data and the non-biometric data to the hub controller 102. The hub controller 102 also may analyze the data received from the store controllers 104 as described above and transmit a customer profile to the store controllers 104 for use by the store controllers 104 and the POS devices 108.

Once a customer profile has been received by the store controllers 104, can forward the customer profile or information from the POS devices 108 as needed. For example, a loyalty rewards number stored in the customer profile may be transmitted to a particular POS device so that purchases can be tracked and associated with the user's loyalty rewards.

The sensors 106 and the store controllers 104 may also track the user's movements at the retail location. For example, once the user's identity is known to the store controllers 104 images can continue to be received at the store controllers 104 and analyzed to identify when the user changes location within the retail location. To assist with identifying the location, markings may be made on the ground that correspond to a particular location. For example, an isle number may be located on the floor and detected by the sensors. By tracking the user's location within at the retail location, shopping preferences of the customer can be obtained. Using these shopping preferences promotions can be sent to the mobile device 110. The promotions can be sent to the mobile device 110 by the hub controller 102 or the store controllers 104 via the network 108.

When the customer leaves the retail location, the store controllers associated with that location may update the users profile and transmit it back to the hub controller 102. As disclosed herein, the majority, or even all, of the analysis of the biometric data and non-biometric data may be done by the store controllers 104. By having the store controllers do at least the majority of the analysis, computing power of the hub controller 102 can be reduces as well as bandwidth usage between the hub controller 102 and the store controllers 104. The reduce bandwidth usage may also result in lower latency between the hub controller 102 and the store controllers 104.

Consistent with embodiments disclosed herein, more than one store controller may be located at a retail location. For example, a retail location may have 100s or even 1,000s of sensors and POS devices. To process the data from such a large number of sensors and POS devices, the retail location may utilize more than one store controller to distribute the workload.

The hub controller 102 can be a single computer or multiple computers as well. For example, a large retailer may have 1,000s or 10,000s of locations. The store controllers for each of the locations may be assigned a region (e.g., southeast, northeast, northcentral, etc.) and one or more hub controllers 102 can be assigned to collect, analyze, and aggregate data from the various store controllers.

The hub controllers 102 may also distribute information to store controllers 104 unsolicited (i.e., push data). For example, if a customer's data shows he or she generally shops at a particular location or locations, then the customer's data can be pushed to the store controllers 104 for that location or locations to reduce bandwidth and latency issues. In addition, the hub controller 104 may distribute promotion information such as coupons, discounts for different tiers of loyalty member, etc. to the store controllers 104 so that the store controllers 104 do not have to request the information for every customer identified.

During use, some customers may not have a customer profile or otherwise be identifiable by the system 100. For instance, a customer may be a first-time shopper at a particular merchant or simply never signed up for the merchant's loyalty program. The system 100 may still track the customer and create a John/Jane Doe profile for the customer. For instance, upon arriving at the retail location, the system 100 may capture images of the customer and fail to identify the customer. The system 100 may create a blank profile only identified by a reference number. Should the customer ever join the merchant's loyalty program, the system 100 may match the customer profile to the customer.

For example, a customer may frequently shop at a merchant's location, but never sign up for its loyalty program. The user may always pay with check, debit card, or credit card. Once the customer signs up for the merchant's loyalty program and uses his or her credit card, debit card, or check, the account numbers for two profiles will match. Stated another way, the John/Jane Doe profile previously created for the user will have the customer's account information and the new profile created when the customer signed up for the loyalty program will also have the customer's account information. Either the store controllers 102 or the hub control 102 can detect a match in the John/Jane Doe account information and the customer's newly created profile and merge the two.

The POS devices 108 may also include sensors that can identify the customer. For example, the POS devices 108 may have a camera that may capture an image of the customer for identification and authentication purposes. This authentication may allow the customer to purchase items with store credit, a credit card on file with the merchant, or otherwise act to authenticate the customer. For instance, if the customer always uses the same credit card, the POS device 108 capturing the image for authentication purposes may act as the cashier asking the customer for identification when using the credit card.

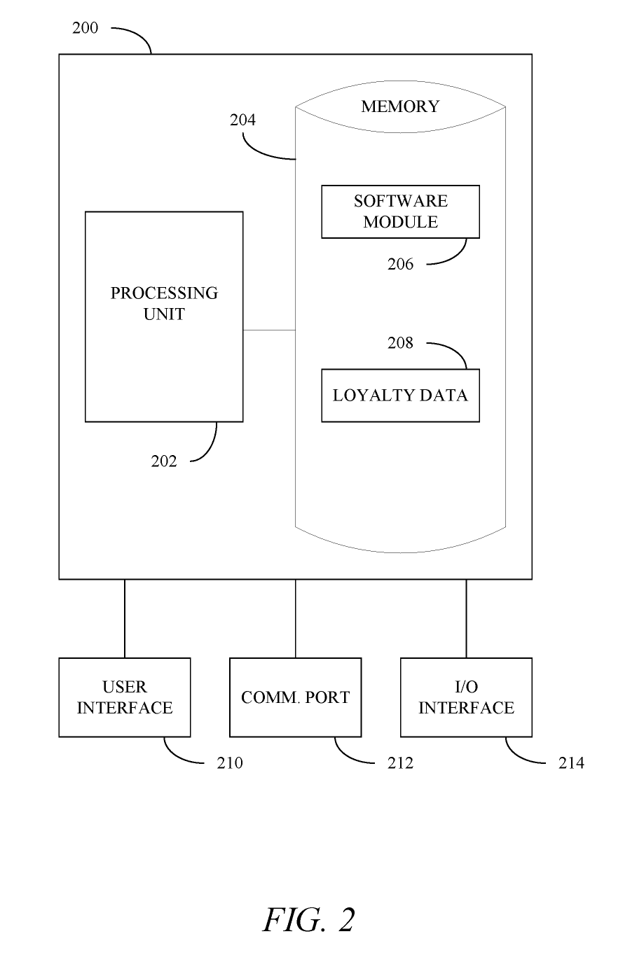

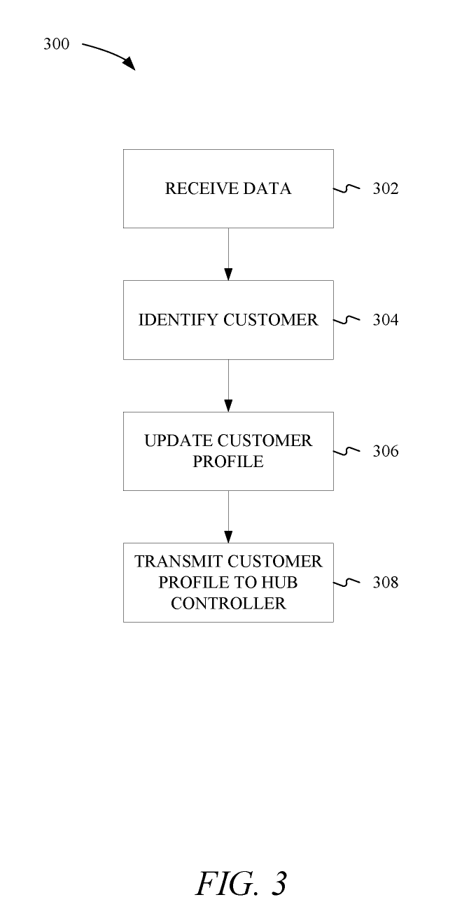

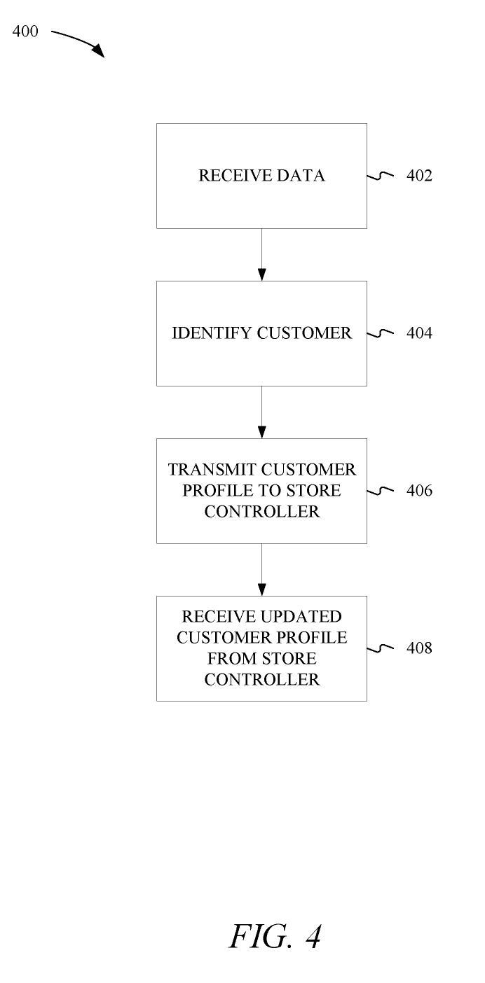

FIG. 2 shows an example schematic of a computing device 200. The computing device 200 may be the hub controller 102, the store controllers 104, or the POS devices 108. As shown in FIG. 2, the computing device 200 may include a processing unit 202 and a memory unit 204. Memory unit 204 may include a software module 206 and loyalty data 208. While executing on processing unit 202, software module 204 may perform processes for selecting and making a payment, including, for example, one or more stages included in method 300, or the method 400 described below with respect to FIGS. 3 and 4. The loyalty data 208 may include customer profiles that include known images of customer, loyalty point balances, shopping habits, purchase histories, and other account information as disclosed herein.

The computing device 200 may also include a user interface 210. User interface 210 may include any number of devices that allow a user to interface with the computing device 200. Non-limiting examples of user interface 210 include a keypad, a microphone, a speaker, a display (touchscreen or otherwise), etc.

The computing device 200 may also include a communications port 212. Communications port 212 may allow the computing device 200 to communicate with information systems and POS systems such as those described above with regard to FIG. 1. Non-limiting examples of communications port 212 include, Ethernet cards (wireless or wired), Bluetooth® transmitters and receivers, near-field communications modules, etc.

The computing device 200 may also include an input/output (I/O) device 214. I/O device 214 may allow the computing device 200 to receive and output information. Non-limiting examples of I/O device 214 include, a camera (still or video), a printer, a scanner, etc.

The computing device 200 may be implemented using a personal computer, a network computer, a mainframe, a handheld device, a personal digital assistant, a smartphone, or any other similar microcomputer-based workstation.

FIG. 3 shows an example method 300 for authenticating a customer. The method 300 may begin at stage 302 where biometric data may be received at a store controller. For example, as disclosed herein, cameras or other sensors may collect biometric data such as images of the customer and transmit the data to store controllers.

From stage 302, the method 300 may proceed to stage 304 where a customer identity may be determined based on the biometric data received. The customer identity may be associated with a customer profile as disclosed herein. For example, the store controller may use an image of the customer and facial recognition technologies to match the image with a known customer.

From stage 304, the method 300 may proceed to stage 306 where the customer profile may be updated. For instance, as disclosed herein, a particular camera may be associated with a particular location within the retail location or the location may have a marking, such as a marking on the ground, that identifies the location. Using the change in location, the customer's shopping preferences can be updated. In addition, purchases, and other interaction in the retail location can be tracked and the customer profile updated according.

From stage 306, the method 300 may proceed to stage 308 where the customer profile may be transmitted to the hub controller. For instance, as disclosed herein, once the customer profile is updated it may be transmitted to the hub controller for analysis or storage.

FIG. 4 shows an example method 400 for authenticating a customer. The method 400 may begin at stage 402 where biometric data may be received from a store controller. For example, as disclosed herein, cameras or other sensors may collect biometric data such as images of the customer and transmit the data to store controllers, which may in turn transmit the biometric data to the hub controller.

From stage 402, the method 400 may proceed to stage 404 where a customer identity may be determined based on the biometric data received. As disclosed herein, the hub controller may use an image of the customer captured by a camera, a known image of the customer, and facial recognition technologies to determine the identity of the customer. The customer identity may be associated with a customer profile as disclosed herein.

From stage 404, the method 400 may proceed to stage 406 where the customer profile may be transmitted to the store controller. For example, as disclosed herein, the customer profile may be transmitted to the store controller to be used by the store controller to track the customer and otherwise update the customer's profile.

From stage 406, the method 400 may proceed to stage 408 where the customer profile may be received by the hub controller from the store controller. For instance, as disclosed herein, once the customer profile is updated by the store controllers it may be transmitted to the hub controller for analysis or storage.

### EXAMPLES

Example 1 is a method of authenticating a customer, the method comprising: receiving, at a computing device comprising a processor, biometric data for the customer; determining, by the computing device, a customer identity based on the biometric data, the customer identity associated with a customer profile; and transmitting, by the computing device, the customer profile to a remote computer.

In Example 2, the subject matter of Example 1 optionally includes wherein receiving the biometric data includes receiving a plurality if images of the customer from a plurality of cameras located at a retail location.

In Example 3, the subject matter of any one or more of Examples 1-2 optionally include determining a location of the customer within a retail location.

In Example 4, the subject matter of any one or more of Examples 1-3 optionally include determining a change in location of the customer within a retail location; and transmitting the change in location to the remote computer.

In Example 5, the subject matter of any one or more of Examples 1-4 optionally include transmitting a promotion to the customer based on an amount of time the customer is at a location within the retail location.

In Example 6, the subject matter of Example 5 optionally includes wherein the promotion is first received from the remote computer before being transmitted to the customer.

In Example 7, the subject matter of any one or more of Examples 1-6 optionally include receiving updated customer profile data; and transmitting an updated customer profile to the remote computer, the updated customer profile including the updated customer profile data.

Example 8 is a method of authenticating a customer, the method comprising: receiving, at a hub controller comprising a processor, biometric data for the customer from a store controller; determining, by the by the hub controller, a customer identity bases on the biometric data, the customer identity associated with a customer profile; and transmitting, by the hub controller, the customer profile to the store controller.

In Example 9, the subject matter of Example 8 optionally includes wherein the biometric data includes an image of the customer captured by a camera located within a retail location and in electrical communication with the store controller.

In Example 10, the subject matter of any one or more of Examples 8-9 optionally include receiving, at the hub controller from the store controller, an updated user profile.

In Example 11, the subject matter of any one or more of Examples 8-10 optionally include transmitting, by the hub controller, a promotion to a mobile device associated with the customer.

Example 12 is a system for authenticating a customer, the system comprising: a plurality of sensors located throughout a retail location; and a store controller having a processor in electrical communication with the plurality of sensors and a memory that stores instructions that, when executed by the processor, cause the processor to: receive biometric data for the customer from at least one of the plurality of sensors, determine a customer identity based on the biometric data, the customer identity associated with a customer profile, and transmit the customer profile to a hub controller.

In Example 13, the subject matter of Example 12 optionally includes wherein the hub controller is associated with a plurality of store controllers, the store controller being one of the plurality of store controllers.

In Example 14, the subject matter of any one or more of Examples 12-13 optionally include wherein the plurality of sensors include a plurality of cameras and the biometric data includes an image of the customer.

In Example 15, the subject matter of any one or more of Examples 12-14 optionally include wherein the instructions, when executed by the processor, further cause the processor to determine a location of the customer within the retail location.

In Example 16, the subject matter of any one or more of Examples 12-15 optionally include wherein the instructions, when executed by the processor, further cause the processor to: determine a change in location of the customer within a retail location; and transmit the change in location to the remote computer.

In Example 17, the subject matter of any one or more of Examples 12-16 optionally include wherein the instructions, when executed by the processor, further cause the processor to transmit a promotion to the customer based on an amount of time the customer is at a location within the retail location.

In Example 18, the subject matter of Example 17 optionally includes wherein the promotion is first received from the hub controller before being transmitted to the customer.

In Example 19, the subject matter of any one or more of Examples 12-18 optionally include wherein the instructions, when executed by the processor, further cause the processor to: receive updated customer profile data; and transmit an updated customer profile to the hub controller, the updated customer profile including the updated customer profile data.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method of authenticating a customer, the method comprising:
receiving, at a computing device comprising a processor, biometric data for the customer;
determining, by the computing device, a customer identity based on the biometric data, the customer identity associated with a customer profile; and
transmitting, by the computing device, the customer profile to a remote computer.

2. The method of claim 1, wherein receiving the biometric data includes receiving a plurality if images of the customer from a plurality of cameras located at a retail location.

3. The method of claim 1, further comprising determining a location of the customer within a retail location.

4. The method of claim 1, further comprising:
determining a change in location of the customer within a retail location; and
transmitting the change in location to the remote computer.

5. The method of claim 1, further comprising transmitting a promotion to the customer based on an amount of time the customer is at a location within the retail location.

6. The method of claim 5, wherein the promotion is first received from the remote computer before being transmitted to the customer.

7. The method of claim 1, further comprising:
receiving updated customer profile data; and
transmitting an updated customer profile to the remote computer, the updated customer profile including the updated customer profile data.

8. A method of authenticating a customer, the method comprising:
receiving, at a hub controller comprising a processor, biometric data for the customer from a store controller;
determining, by the by the hub controller, a customer identity bases on the biometric data, the customer identity associated with a customer profile; and
transmitting, by the hub controller, the customer profile to the store controller.

9. The method of claim 8, wherein the biometric data includes an image of the customer captured by a camera located within a retail location and in electrical communication with the store controller.

10. The method of claim 8, further comprising receiving, at the hub controller from the store controller, an updated customer profile.

11. The method of claim 8, further comprising transmitting, by the hub controller, a promotion to a mobile device associated with the customer.

12. A system for authenticating a customer, the system comprising:
a plurality of sensors located throughout a retail location; and
a store controller having a processor in electrical communication with the plurality of sensors and a memory that stores instructions that, when executed by the processor, cause the processor to:
receive biometric data for the customer from at least one of the plurality of sensors,
determine a customer identity based on the biometric data, the customer identity associated with a customer profile, and
transmit the customer profile to a hub controller.

13. The system of claim 12, wherein the hub controller is associated with a plurality of store controllers, the store controller being one of the plurality of store controllers.

14. The system of claim 12, wherein the plurality of sensors include a plurality of cameras and the biometric data includes an image of the customer.

16. The system of claim 12, wherein the instructions, when executed by the processor, further cause the processor to determine a location of the customer within the retail location.

17. The system of claim 12, wherein the instructions, when executed by the processor, further cause the processor to:
determine a change in location of the customer within a retail location; and
transmit the change in location to the remote computer.

18. The system of claim 12, wherein the instructions, when executed by the processor, further cause the processor to transmit a promotion to the customer based on an amount of time the customer is at a location within the retail location.

19. The system of claim 18, wherein the promotion is first received from the hub controller before being transmitted to the customer.

20. The system of claim 12, wherein the instructions, when executed by the processor, further cause the processor to:
receive updated customer profile data; and
transmit an updated customer profile to the hub controller, the updated customer profile including the updated customer profile data.
